(19) United States
(12) Patent Application Publication
(10) Pub. No.: US 2005/0125532 A1
(43) Pub. Date: Jun. 9, 2005

(54) Traversing firewalls and nats

(76) Inventor: Gur Kimchi, Bellevue, WA (US)

Correspondence Address: KATTEN MUCHIN ZAVIS ROSENMAN, 575 MADISON AVENUE, NEW YORK, NY, 10022-2585, US

(21) Appl. No.: 10/450,751

(22) PCT Filed: Dec. 13, 2001
(86) PCT No.: PCT/US01/48551

Related U.S. Application Data
(63) Continuation-in-part of application No. 09/867,371, filed on May 29, 2001.
(60) Provisional application No. 60/255,422, filed on Dec. 14, 2000.
(60) Provisional application No. 60/207,701, filed on May 26, 2000.

(51) Int. Cl. G06F 15/173; G06F 12/14; H04L 9/32

(52) U.S. Cl. 709/225; 713/201

(57) ABSTRACT

An incoming UDP packet is allowed to traverse a network address translation (NAT) device or a firewall, wherein first, a TCP connection is opened and a Raw-IP interface is utilized to build the UDP-like packet using the parameters of the TCP connection (e.g., session number, port, etc.) Furthermore, when one of two communicating machines is behind a firewall, a connection is established between each of the machines and a proxy server located in a public network. The proxy then communicates the port and address information while using the proxy server's port and address information as the source port and address, or provides both with an address of an appropriate (potentially based on network proximity) packet forwarder.

### RELATED APPLICATIONS

The present application claims the benefit of provisional patent application “Traversing Firewalls and NATs”, Ser. No. 60/255,422, filed Dec. 14, 2000. In addition, this application incorporates by reference, co-pending U.S. patent application Ser. No. 09/867,371, filed May 29, 2001.

### BACKGROUND OF THE INVENTION

1. Field of Invention

The present invention relates generally to the field of network communications. More specifically, the present invention is related to a system and method for traversing firewalls and network address translators (NATs).

2. Discussion of Prior Art

NATs and firewalls present a challenge to a network software programming, while their functions and operations are different: firewalls filter information into and out of the private network, while NATs hide or encapsulate a private network behind a single (or few) “real” Internet Protocol addresses. Their effect on many network applications is the same:
The inability to send and receive information when receiving information using UDP (e.g., UDP data-grams coming into the private network).
The inability to send and receive information when opening TCP communications into the private network.

Each of the below described references teach the method of firewalls in general. However, none of the references provide or suggest the present invention method of ATM over IP traversing firewalls and network address translators (NATs).

U.S. Pat. No. 5,898,830, assigned to Network Engineering Software describes a system, which allows connectionless traffic across a firewall. Rule checking is performed on the first packet entering, and if it is determined that the packet needs to be sent, a virtual host sends it to the destination computer. A time limit is set and so long as the set time limit does not run out, the communication is allowed. Addressing is accomplished utilizing name based addressing for end-to-end communication, with virtual hosts/DNS servers providing the intermediate address routing information. A connection type session does not appear to be initiated for the UDP transport.

U.S. Pat. No. 5,915,087 discloses a firewall system, which allows communication, using a connectionless protocol. The firewall holds a list of servers located on the private side, and intercepts any communications addressed to the servers. The firewall then binds a port and notes it in a link table. The packet is passed to a stack, on the private side, which forwards the packet to the server. Any communications from the server to the originating client is sent to the firewall, where the originating clients address is determined using the link table.

U.S. Pat. No. 5,778,174 describes a system, which utilizes an external machine, located on a public network to bypass a router firewall. A client on the public network connects to the external machine. A private channel is opened between the external machine and a machine internal to the private network. The internal machine connects to the destination server, and communication between the client and server is conducted through the external and internal machines.

U.S. Pat. No. 5,941,988 provides for a proxy system that “glues” together two separate TCP connections terminating at a common host (proxy). When communications from one connection are received at the proxy, the headers are altered to address the socket at the end of the second connection, and the sequence numbers of the first connection are mapped to the sequence space of the second connection.

The non-patent literature entitled, “A Weakness in the 4.2 BSD Unix TCP/IP Software” describes the spoofing of a trusted host to communicate with a system, having a list of the trusted hosts, from a host that is not on the trusted list.

It should however be noted that the prior art described above fails to provide many features, for example an explicit recitation of opening a connection-oriented session in order to allow connectionless data-grams to pass through a NAT/firewall is not provided. Additionally, none of the prior art described above uses a proxy server to exchange respective address information between two hosts and the hosts communicating directly via the address information and spoofing the proxy, in order to traverse at least one firewall.

Whatever the precise merits, features and advantages of the above cited references, none of them achieve or fulfills the purposes of the present invention.

### SUMMARY OF THE INVENTION

The present invention provides for a method and a system for allowing an incoming UDP packet to traverse a NAT/firewall comprising, opening a TCP connection and utilizing a Raw-IP interface which builds the UDP packet utilizing the parameters of the TCP connection (e.g., session number, port, etc.).

Furthermore, the present system provides for a method and system for allowing communication between two machines, at least one of which is behind a firewall. Connections are established between each machine and a proxy server sitting on a public network. The proxy then communicates the port and address information of each machine to the other machine, after which, each machine sends directly to each other using the supplied port and address information, while using the proxy servers port and address information as the source port and address.

### BRIEF DESCRIPTION OF THE DRAWINGS

FIG. 1 illustrates the Intranet to Internet data transfer scenario.

FIG. 2 illustrates the Internet to Intranet data transfer scenario.

FIG. 3 illustrates the Intranet to Intranet data transfer scenario.

FIG. 4 illustrates a bi-directional connection, using TCP and HTTP, communicating indirectly with the proxy.

FIG. 5 illustrates TCP spoofing of the present invention.

FIG. 6 illustrates TCP spoofing of the present invention in the presence of a packet forwarder.

FIG. 7 illustrates the methodology associated with the present invention.

### DESCRIPTION OF THE PREFERRED EMBODIMENTS

While this invention is illustrated and described in a preferred embodiment, the invention may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

When a communicating device, such as the Internet phone or a Voice-over-IP Gateway or an IETF MGCP Gateway or an ITU-T H.248 Gateway or a PacketCable Residential Gateway or a CPE Gateway (Customer premises equipment Gateway), opens a signaling connection from a private network to a public network, the TCP channel is bi-directional, and therefore the signaling protocol can execute in both directions. This also allows HTTP to work behind network address translators (NATs) and Firewalls. Connections are always opened from the private network to the public network; taking advantage of the fact that TCP data communications are bi-directional.

NATs present an additional translation step when communicating. NATs map the source addresses (in the private network) of the originating computer into a public address and a port number on the public interface of the NAT.

As long as TCP is used, the translation can be done in reverse, as the TCP channel is bi-directional. Multimedia signaling and media streaming is usually UDP-based for better efficiency, which introduces the problem—the ingress system sends UDP packets to the public interface on the NAT, and the NAT has no automatic method to map this UDP data-gram to the actual computer that is supposed to receive that data-gram.

The solution provided by the present invention is to stream audio and video (and other time-sensitive data) over TCP, but TCP streaming and windowing mechanizing hurts the real-time performance. The present invention opens a TCP connection as usual (using TCP), and then switches to a Raw-IP interface that sends Raw-IP data-grams that are legal TCP messages using just opened TCP channel parameters (e.g., session number, port, etc.) To an intermediate system, these messages will look like standard TCP messages, but as they are sent using Raw-IP, the usual timing issues that TCP introduces to real-time media streaming are not in place. Thus, the present invention uses the protocol software to “spoof” the TCP channel to enable real-time TCP communications.

It is impossible with NATs and Firewalls to open ingress connections (e.g., it is impossible to open a TCP connection to a computer behind a Firewall or the NAT. Thus:
1. It is impossible to originate communications from the public network into the private network.
2. It is impossible to originate communications from a private network (to a public network) to another private network.

Thus, the present invention uses a server proxy that both communication parties open their TCP channels to (using the previous procedure). Then, the proxy communicates to each party the other party's source address/port (of the TCP channel). Finally, each communication element sends information to the other party using the server proxy source address/port. It should be noted that packets are sent directly between the communicating entities, as the proxy is only used to hold the TCP state to “spoof” the NATs and Firewalls.

In the preferred embodiment of the present invention, full communication is possible between all types of private and public networks, as long as outgoing TCP channel establishment is allowed. In another embodiment, the server proxy and originating clients use TCP/HTTP, which is universally supported, and in this instance, all information is tunneled over the simulated TCP/HTTP channel.

In the Internet as it exists today, using the small address space provided by IPv4, many networks deploy NAT (network address translation) devices to enlarge the internal address space. In addition, many networks deploy firewall devices to block intrusions and hacking. Many firewalls also support integrated NAT capabilities.

The end-result of both types of devices is that ingress traffic (one originating outside the network and destined into the network) is usually blocked, as incoming connections are usually blocked for firewalls and are impossible to complete on NAT devices, and as the originating (outside the NAT) IP host is unaware of the destination internal IP address. Thus, users cannot place audio/video calls from NAT protected networks (as the audio and video will not penetrate back into the network from the remote called host), and in many cases users behind corporate firewalls are blocked from using such services.

A communications protocol such as the TrulyGlobal™ Protocol (TGP), (as described in the related application, “Communication Protocol”) can be used in conjunction with the present invention to operate over standard HTTP and remote TGP servers to use the HTTP back-channel to send information to the client; and ensuring that all actions carried by TGP traverse both NATs and firewalls.

Intranet, as defined in this application, is a network that is protected by a NAT or a firewall device, and blocks all incoming traffic into the protected network (e.g., TCP connections cannot be initiated into the network, and UDP traffic will be blocked at the entry-point into the network). Similarly, Internet is defined as a public addressed, unprotected network, where fill IP communication is possible.

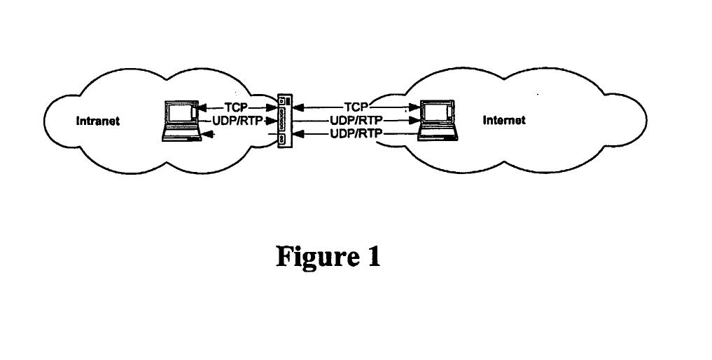

In the Intranet to Internet scenario, as illustrated in FIG. 1, a user inside an Intranet is attempting to call a user that is outside the Intranet, and the remote user is in the public Intranet. The problem encountered is that while the call will be successfully set-up (as the originating host is allowed to open connection to the outside network), audio and/or video data will not be able to get back into the Intranet, hence the caller will not be able to hear and/or see the called device.

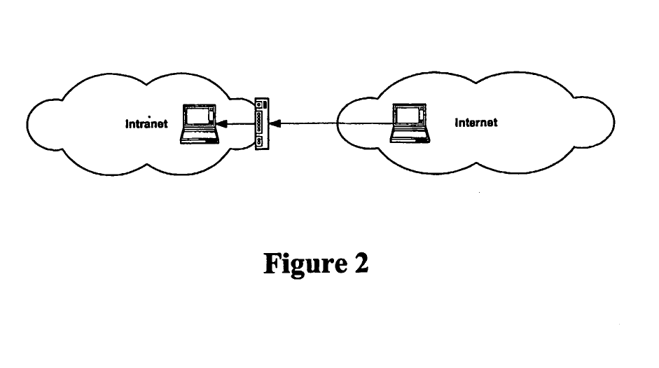

Similarly, in an Internet to Intranet scenario, as illustrated in FIG. 2, the caller cannot open a signaling channel at all to the called device, as ingress connections into the Intranet are not allowed.

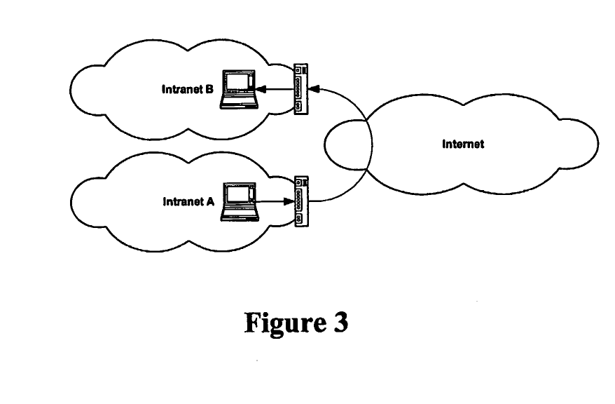

Lastly, in the Intranet to Intranet scenario, as illustrated in FIG. 3, the same end-effect as the previous scenario happens, e.g., the caller cannot open a signaling channel at all to the called device, as ingress connections into the Intranet from the Internet are not allowed.

The solution provided for by the present invention uses TCP and potentially HTTP, and a service is provided outside the Intranet (in the public Internet) to help both end-points to complete calls. The first assumption made is that the clients inside the Intranet can initiate TCP or at least TCP/HTTP specifically to the public Internet, so some form of communications is possible. HTTP can be used to insure safe traversal via HTTP proxies.

Once a TCP/HTTP connection is available, bi-directional communications are possible. Outwards messages use standard HTTP commands to request resources (using URLs), and incoming information flow returns using the HTTP reply channel (as TCP/HTTP is full-duplex).

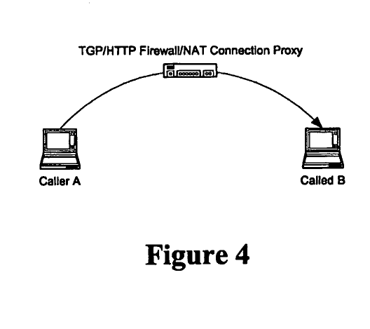

Furthermore, at any time, as illustrated by FIG. 4, the caller can initiate a TCP/HTTP connection (or a plain TCP connection) to a service that resides in the public Internet, and that service is responsible to “proxy” the request (using the reply leg of the remote HTTP session) to the called-device. When both devices have bi-directional connections to the proxy, they can communicate indirectly via the proxy.

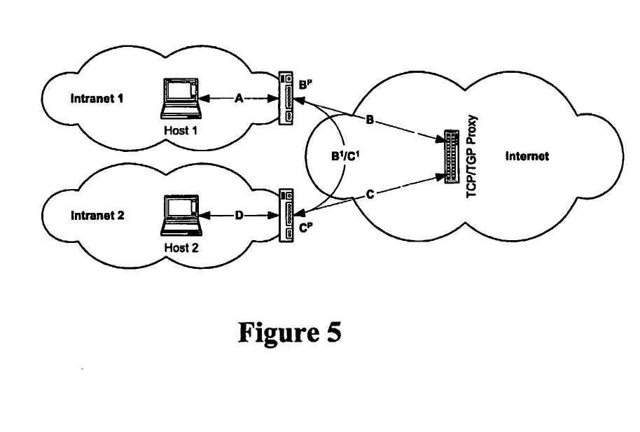

While the present invention shows how proxy-based communication can work, the problem when the communication between the two hosts has to flow via the proxy, which adds delay and has limited scalability. The solution as per the present invention is to spoof the TCP session to allow direct TCP communications between the two machines. This scenario is illustrated in FIG. 5. When a machine behind a proxy, NAT or firewall establishes a session with the outside world, the session is mapped on the outside of Intranet 1 and 2 on the public interface address(s) to an internal connection between Host 1 and 2 and their gateways to the Internet. Sending correctly formed TCP packets to that interface will result in the gateway forwarding these packets to the correct host inside the private network.

The sequence is as follows:
1. A session is established from Host 1 in Intranet 1 to the Proxy (AB session).
2. A session is established from Host 2 in Intranet 2 to the Proxy (DC session).
3. The Address B^{P} (public side of session A) is found by inspecting the source address/port of B.
4. The Address of C^{P} (public side of session D) is found by inspecting the source address/port of C.
5. The external mapped addresses are provided to the other hosts, i.e., Host 1 is provided with address/pair C^{P} and Host 2 is provided with address/port pair B^{P}.
   TCP session B parameters are provided to host 2.
   TCP session C parameters are provided to host 1.
6. Hosts 1 and 2 will spoof TCP packets for sessions B and C, sent to target
   address/port pairs B^{P} and C^{P}. This traffic will go directly between the two networks and not via the Proxy. In effect, a virtual TCP session C¹/B¹ is created by combining the two existing TCP sessions C and B.

Once the spoofed TCP session is handed over to Hosts 1 and 2, the Proxy should not send any information on that session, as session parameters may be out-of-date. The session is kept open for the duration Hosts 1 and 2 requires it, and will be closed by either Host when required. The proxy is only used for establishing session, and does not use the session for anything else once it is “handed over”.

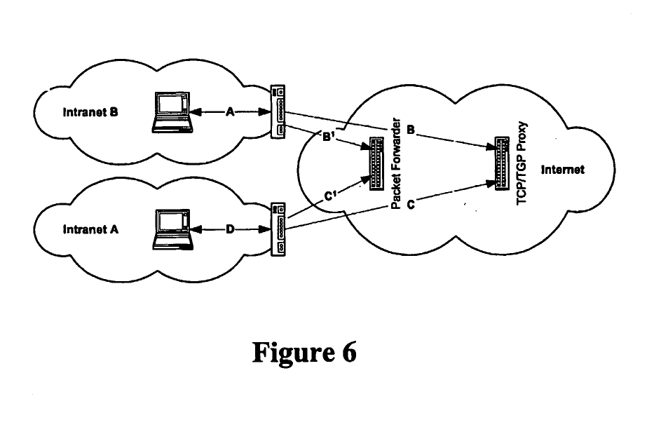

In some cases the internal network will filter spoofed packets (for security, e.g., hack prevention) and therefore will not let the packets with the spoofed source address leave the internal network. In such cases, as illustrated by FIG. 6, the TCP connections will be handed over to a packet forwarder (that resides in the same server or a separate server) that handles the packet interchange.

One of the side effects of spoofing the TCP session between Hosts 1 and 2 is that the TCP session parameters can be changed or completely ignored, as long as packets are synthetically correct (as per TCP), they can be sent without consideration to window-sizes, exponential back-off algorithms or slow-start mechanisms. When such a spoofed TCP session is in place, it can be used to transmit both audio and video with the same time of performance that is expected from UDP.

The session-establishment procedures described above allow any session to be established between any two computers. This is done as a result of Host 1 calling Host 2 (or the reverse). The calling host will send a Call-Establishment message to the Proxy, which will (pending, any policy decision) forward the request to the called Host. The called host will receive the Call Answer transaction over the back-channel of the session it already has with the Proxy, requesting it to answer the call. If the called host responses positively, one or more media channel(s) will be established between Host 1 and 2, with the help of the proxy as required by the session's parameters (audio only, audio and video, etc).

It should be noted that both IETF SIP and ITU-T H.323 signaling can be used, but are not required. In one embodiment, the Proxy contains all the required functionality (e.g., signaling a RTP:Address:Port destination instead of a H323:Address:Port destination).

Furthermore, one skilled in the art can recognize that IETF SIP (by manipulating IETF Session Description Protocol (SDP) parameters) and ITU H.323 (by Manipulating ITU-T H.245 OpenLogicalChannel or FastStart parameters) can be used, with minor changes, to accomplish the required signaling.

The present invention is implemented using a raw-IP interfaces that spoofs the TCP sessions. A limited TCP stack is implemented that creates synthetically correct TCP packets, to insure the packets are interpreted and forwarded correctly by the NATs, proxies and firewalls in the way. Such a spoofed-TCP stack does not need to support any reliable transmission, as it is only used for real-time sensitive transmission purposes.

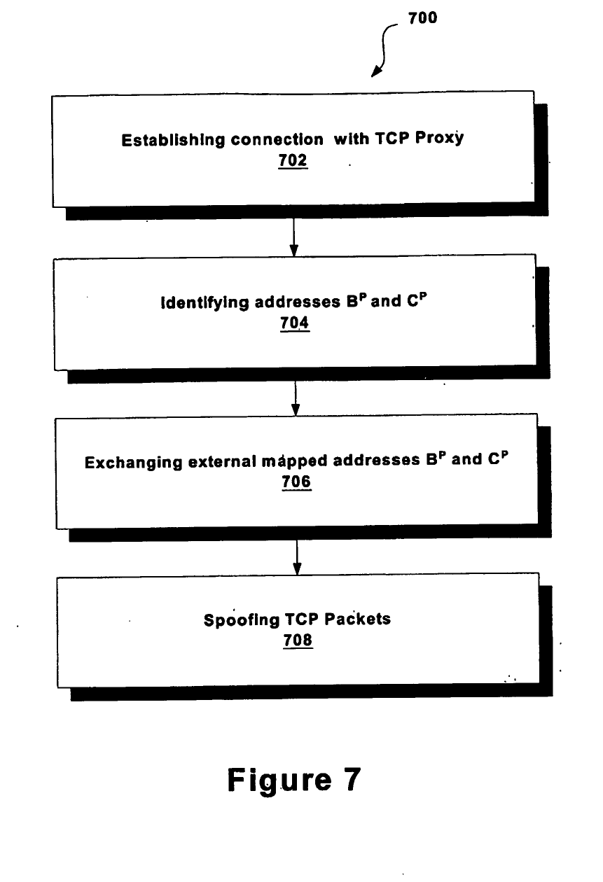

FIG. 7 summarizes the methodology 700 associated with the present invention. In step 702, both hosts establish a connection (e.g., TCP connection or TCP/HTTP connection) with a TCP proxy server. Next, in step 704, external mapped addresses B^{P} and C^{P} associated with the firewalls of both hosts are identified. Subsequently, in step 706, the identified external mapped addresses are exchanged between the two hosts. Lastly, the TCP packets are spoofed to transmit the data (e.g., streaming multimedia data) between the hosts.

Furthermore, the present invention includes a computer program code based product, which is a storage medium having program code stored therein, which can be used to instruct a computer to perform any of the methods associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory, or data storage devices.

Implemented in computer program code based products are software modules for: aiding in establishing a communication link with a proxy server over a network, wherein a first and second device can access the network over a firewall; inspecting said firewalls and identifying an external mapped addresses B^{P} associated with said first device and identifying an external mapped address C^{P} associated with said second device; notifying said first device regarding said identified external mapped address C^{P} and notifying said second device regarding said identified external mapped address B^{P}; and aiding said first or second device in spoofing TCP packets via transmitting data with said notified external mapped address as the destination address.

Also implemented in computer program based products are software modules for: aiding in establishing a communication link with a proxy server over a network, each of said first and second devices accessing said network over a firewall; inspecting said firewalls and identifying an external mapped addresses B^{P} associated with said first device and identifying an external mapped address C^{P} associated with said second device; notifying said packet forwarder regarding said identified external mapped addresses C^{P} and B^{P}, and forwarding TCP packets via transmitting data with said packet forwarder as said destination address and computer readable program code aiding said packet forwarder in forwarding said data with C^{P} as the destination address, or forwarding TCP packets via transmitting data with said packet forwarder as said destination address and computer readable program code aiding said packet forwarder in forwarding said data with B^{P} as the destination address.

### CONCLUSION

A system and method has been shown in the above embodiments for the effective implementation of a method and a system for traversing firewalls and network address translations (NATs). While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by type of firewall, type of network address translation device, location of packet forwarder, software/program, computing environment, or specific computing hardware.

The above enhancements are implemented in various computing environments. For example, the present invention may be implemented on a multi-nodal system (e.g., LAN) or networking system (e.g., Internet, WWW, wireless web). All programming, and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of network communications.

1. A method for transmitting data between a first and second device by traversing firewalls, said method comprising the steps of:
a. said first and second device establishing a communication link with a proxy server over a network, each of said first and second devices accessing said network over a firewall;
b. said proxy server inspecting said firewalls and identifying an external mapped addresses B^{P} associated with said first device and identifying an external mapped address C^{P} associated with said second device;
c. said proxy server notifying said first device regarding said identified external mapped address C^{P} and said proxy server notifying said second device regarding said identified external mapped address B^{P}, and
d. said first or second device spoofing TCP packets via transmitting data with said notified external mapped address as the destination address.

2. A method for transmitting data between a first and second device by traversing firewalls, as per claim 1, wherein said step of spoofing TCP packets is done via Raw-IP datagrams.

3. A method for transmitting data between a first and second device by traversing firewalls, as per claim 1, wherein said communication link is established via TCP.

4. A method for transmitting data between a first and second device by traversing firewalls, as per claim 1, wherein said communication link is established via TCP/HTTP.

5. A method for transmitting data between a first and second device by traversing firewalls, as per claim 1, wherein said firewall is equipped with a network address translation device (NAT).

6. A method for transmitting data between a first and second device by traversing firewalls, as per claim 1, wherein said network is any of: local area network (LAN), wide area network (WAN), wireless network, or the Internet.

7. A method for transmitting data between a first and second device by traversing firewalls, as per claim 1, wherein said data is streaming multimedia data.

8. A method for forwarding data between a first and second device by traversing firewalls, said data forwarded via a packet forwarder, said method comprising the steps of:
a. said first and second device establishing a communication link with a proxy server over a network, each of said first and second devices accessing said network over a firewall;
b. said proxy server inspecting said firewalls and identifying an external mapped addresses B^{P} associated with said first device and identifying an external mapped address C^{P} associated with said second device;
c. said proxy server notifying said packet forwarder regarding said identified external mapped addresses C^{P} and B^{P}, and
d. said first device forwarding TCP packets via transmitting data with said packet forwarder as said destination address and said packet forwarder forwarding said data with C^{P} as the destination address, or
said second device forwarding TCP packets via transmitting data with said packet forwarder as said destination address and said packet forwarder forwarding said data with B^{P} as the destination address.

9. A method for forwarding data between a first and second device by traversing firewalls, said data forwarded via a packet forwarder, as per claim 8, wherein said step of forwarding TCP packets is done via Raw-IP datagrams.

10. A method for forwarding data between a first and second device by traversing firewalls, said data forwarded via a packet forwarder, as per. Claim 8, wherein said communication link is established via TCP.

11. A method for forwarding data between a first and second device by traversing firewalls, said data forwarded via a packet forwarder, as per claim 8, wherein said communication link is established via TCP/HTTP.

12. A method for forwarding data between a first and second device by traversing firewalls, said data forwarded via a packet forwarder, as per claim 8, wherein said firewall is equipped with a network address translation device (NAT).

13. A method for forwarding data between a first and second device by traversing firewalls, said data forwarded via a packet forwarder, as per claim 8, wherein said network is any of: local area network (LAN), wide area network (WAN), wireless network, or the Internet.

14. A method for forwarding data between a first and second device by traversing firewalls, said data forwarded via a packet forwarder, as per claim 8, wherein said data is streaming multimedia data.

15. A system for transmitting data between a first and second device by traversing firewalls, said system comprising:
a. a first host and an associated first firewall;
b. a second host and an associated second firewall;
c. a proxy server that establishes a communication link with said first and second host, identifies from said first and second firewalls external mapped addresses B^{P} and C^{P} respectively, and forwards said C^{P} to said first device and forwards said B^{P} to said second device, whereupon said first and second host utilize said forwarded external mapped addresses to spoof TCP packets and forward data directly between each other.

16. A system for transmitting data between a first and second device by traversing firewalls, as per claim 15, wherein said proxy server forwards TCP packets via Raw-IP datagrams.

17. A system for transmitting data between a first and second device by traversing firewalls, as per claim 15, wherein said communication link is established via TCP.

18. A system for transmitting data between a first and second device by traversing firewalls, as per claim 15, wherein said communication link is established via TCP/HTTP.

19. A system for transmitting data between a first and second device by traversing firewalls, as per claim 15, wherein said firewall is equipped with a network address translation device (NAT).

20. A system for transmitting data between a first and second device by traversing firewalls, as per claim 15, wherein said network is any of: local area network (LAN), wide area network (WAN), wireless network, or the Internet.

21. A system for transmitting data between a first and second device by traversing firewalls, as per claim 15, wherein said data is streaming multimedia data.

22. A system for transmitting data between a first and second device by traversing firewalls, said system comprising:
a. a first host and an associated first firewall;
b. a second host and an associated second firewall;
c. a proxy server that establishes a communication link with said first and second host, identifies from said first and second firewalls external mapped addresses B^{P} and C^{P} respectively;
d. a packet forwarder receiving B^{P} and C^{P} from said proxy server and using B^{P} and C^{P} to forward incoming communications from said first device to second device with C^{P} as destination address, or forwarding incoming communications from said second device to first device with B^{P} as the destination address.

23. A system for transmitting data between a first and second device by traversing firewalls, as per claim 22, wherein said packet forwarder forwards TCP packets via Raw-IP datagrams.

24. A system for transmitting data between a first and second device by traversing firewalls, as per claim 22, wherein said communication link is established via TCP.

25. A system for transmitting data between a first and second device by traversing firewalls, as per claim 22, wherein said communication link is established via TCP/HTTP.

26. A system for transmitting data between a first and second device by traversing firewalls, as per claim 22, wherein said firewall is equipped with a network address translation device (NAT).

27. A system for transmitting data between a first and second device by traversing firewalls, as per claim 22, wherein said network is any of: local area network (LAN), wide area network (WAN), wireless network, or the Internet.

28. A system for transmitting data between a first and second device by traversing firewalls, as per claim 22, wherein said data is streaming multimedia data.

29. An article of manufacture comprising a computer usable medium having computer readable program code embodied therein for assisting in the transmission of data between a first and second device by traversing firewalls, said article further comprising:
a. computer readable program code aiding in establishing a communication link with a proxy server over a network, each of said first and second devices accessing said network over a firewall;
b. computer readable program code inspecting said firewalls and identifying an external mapped addresses B^{P} associated with said first device and identifying an external mapped address C^{P} associated with said second device;
c. computer readable program code notifying said first device regarding said identified external mapped address C^{P} and computer readable program code notifying said second device regarding said identified external mapped address B^{P}, and
d. computer readable program code aiding said first or second device in spoofing TCP packets via transmitting data with said notified external mapped address as the destination address.

30. An article of manufacture comprising a computer usable medium having computer readable program code embodied therein for aiding in forwarding data between a first and second device by traversing firewalls, said data forwarded via a packet forwarder, said medium further comprising:
a. computer readable program code aiding in establishing a communication link with a proxy server over a network, each of said first and second devices accessing said network over a firewall;
b. computer readable program code inspecting said firewalls and identifying an external mapped addresses B^{P} associated with said first device and identifying an external mapped address C^{P} associated with said second device;
c. computer readable program code notifying said packet forwarder regarding said identified external mapped addresses C^{P} and B^{P}, and
d. computer readable program code forwarding TCP packets via transmitting data with said packet forwarder as said destination address and computer readable program code aiding said packet forwarder in forwarding said data with C^{P} as the destination address, or
computer readable program code forwarding TCP packets via transmitting data with said packet forwarder as said destination address and computer readable program code aiding said packet forwarder in forwarding said data with B^{P} as the destination address.
